(19) United States
(12) Patent Application Publication
(10) Pub. No.: US 2005/0271934 A1
(43) Pub. Date: Dec. 8, 2005

(54) Battery pack assembly

(76) Inventors: William B. Kiger, Hoschton, GA (US); Kevin K. Maggert, Lawrenceville, GA (US)

Correspondence Address: MOTOROLA INC, 600 NORTH US HIGHWAY 45, ROOM AS437, LIBERTYVILLE, IL, 60048-5343, US

(21) Appl. No.: 10/861,143

(22) Filed: Jun. 5, 2004

(51) Int. Cl. H01M 2/24; H01M 2/02

(52) U.S. Cl. 429/159; 429/164; 429/7

(57) ABSTRACT

A low-profile battery pack having an electrolyte barrier is provided. The pack includes a plurality of rechargeable cells, being arranged in end to end pairs of two cells. A cleavage void formed by the convex geometry of the cells accommodates at least one insulator and a first circuit board. Tabs couple the cells to the first circuit board. A flexible substrate couples the first circuit board to a second circuit board. The assembly is then placed in a housing having a first compartment and a second compartment, such that the cells are placed in the first compartment and the second circuit board is placed in the second compartment. Between the first and second compartments exists an electrolyte barrier. The flexible substrate passes through an opening in the electrolyte barrier. Adhesive placed in the opening, about the flexible substrate, ensures a seal that keeps electrolyte that may appear in the first chamber from passing to the second chamber. The overall battery pack is both compact in size and robust in performance.

### BACKGROUND

1. Technical Field

This invention relates generally to rechargeable battery packs, and more specifically to a low-profile battery pack assembly having electrical and mechanical components arranged so as to reduce overall battery pack size and increase reliability.

2. Background Art

Some people think that a rechargeable battery pack is simply a rechargeable electrochemical cell wrapped in plastic. In reality, rechargeable battery packs are complex systems incorporating numerous components, including cells, protection circuitry, charging circuitry, and mechanical components. These components work in harmony to deliver safe, reliable power to portable electronic devices.

Both the size and cost of electronic devices are rapidly decreasing. In today's modern devices, like cellular telephones, radios and laptop computers, the size of the device has become so small that a large portion of the volume of the host device is occupied by the battery pack. In other words, battery packs sometimes take up more room that any other component in the device. Additionally, the cost of the battery pack can rival the cost of the host device.

Due to this reduction in the overall size of electronic devices, there is pressure on battery designers to reduce the overall dimensions of battery packs. One prior art solution used to reduce the overall size of the battery pack is removing some of the electronic circuitry from the battery pack and incorporating it into the host device. When this is done, electronic circuitry may be taken out of the battery pack and added to the host device's circuitry.

This solution presents two problems: First, host devices must be designed to accommodate a particular battery pack. Since each battery pack requires a specific circuit design, adding the battery circuitry to the host device means that only one battery pack may be used with that particular device. Consequently, the device is unable to take advantage of new battery designs or technologies because the host device's internal circuitry is tailored only to one battery pack.

The second issue is reliability. If the circuitry is removed from the battery pack, certain external conditions may compromise reliability of the battery pack. For example, protection circuitry is often included within the battery pack to protect the battery from an inadvertent shorting of the terminals. If this circuitry is removed, battery reliability may be compromised if the terminals are accidentally shorted while the battery is not coupled to the host device.

There is thus a need for an improved, low-profile battery pack that ensures robust reliability.

### BRIEF DESCRIPTION OF THE DRAWINGS

FIG. 1 illustrates a plurality of cylindrical cells arranged in pairs of two, end to end, in accordance with the invention.

FIG. 2 illustrates a cleavage space formed when two cylindrical cells are arranged adjacent to each other, in accordance with the invention.

FIG. 3 illustrates an insulator in accordance with the invention.

FIG. 4 illustrates a plurality of cell pairs, having insulators disposed within the cleavage space, in accordance with the invention.

FIG. 5 illustrates an exploded view of a cell assembly in accordance with the invention.

FIG. 6 illustrates a cell assembly having insulators, tabs and a first circuit board in accordance with the invention.

FIG. 7 illustrates a cell assembly having a flexible substrate and second circuit board in accordance with the invention.

FIG. 8 illustrates a cell assembly in an open housing in accordance with the invention.

FIG. 9 illustrates a sectional view of a battery pack in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

One preferred embodiment of this invention is a low-profile battery pack capable of bringing multiple cell connections from a plurality of rechargeable, electrochemical cells to an external connector on the outside of the battery pack, while providing an electrolyte barrier between the cells and the external connector. When electrochemical cells malfunction, they occasionally release liquid electrolyte. The electrolyte barrier ensures that any liquid electrolyte that is released within the pack is isolated from the main circuit board and external connector.

The battery pack includes an interconnect printed circuit board (PCB) that is placed within the “cleavage space” between pairs cylindrical cells. The interconnect PCB provides an interface mechanism for each cell connection. It also provides a place for electrical components to be mounted, like thermistors for sensing the temperature of the cells in operation. The interconnect PCB is connected to a second PCB by way of a flexible substrate or circuit. The flexible substrate passes through a water-tight, or liquid impenetrable, barrier in the housing. The assembly offers a very compact, low-profile battery pack that is easy to manufacture. The assembly eliminates the need for hand soldering manufacturing operations, thereby decreasing the possibilities for defects on the manufacturing floor.

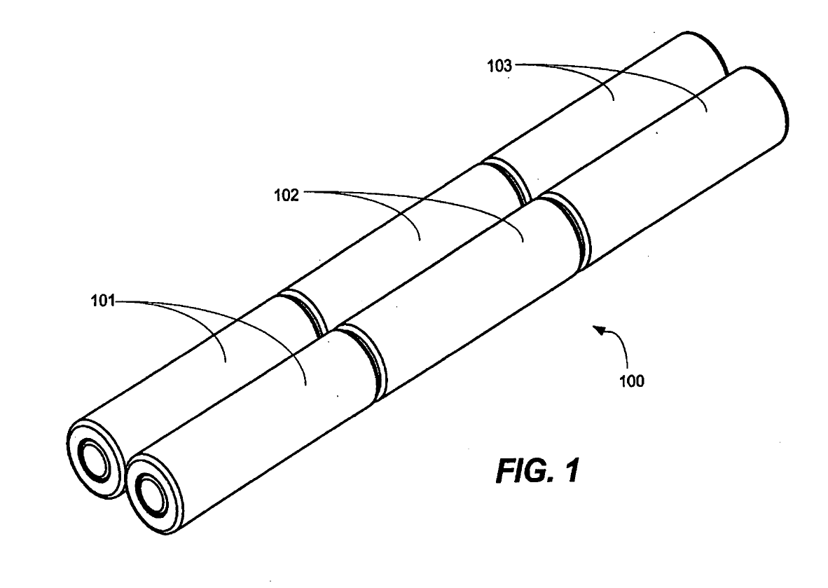

Turning now to FIG. 1, illustrated therein is a plurality of cylindrical, rechargeable, electrochemical cells 100 for use in a battery pack. While the exemplary embodiment of FIG. 1 illustrates 6 cells, the invention may be employed with any number of cells, provided there are at least two. The cells 100 in FIG. 1 are arranged in three pairs 101,102,103 of two cells. The three pairs 101,102,103 are arranged end to end.

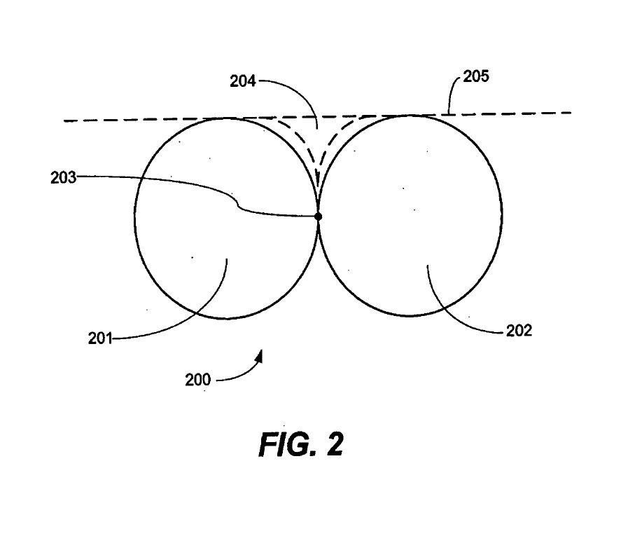

Turning now to FIG. 2, illustrated therein is one pair 200 of the three pairs of two cells from FIG. 1, viewed in cross section. Since the cells 201,202 are cylindrical in shape, the cross section of each cell is, of course, a circle. When the two cells 201,202 are placed adjacent to each other, as shown in FIG. 2, they intersect at a line 203, shown here as a dot (indicating a line that runs into the page). The intersection is a line 203 because the exterior casing of each cell 201,202 is a convex curvature. The intersection of these convex curvatures is represented by line 203, which runs the length of the cells.

Due to this adjacent arrangement, a “cleavage space” 204 is formed between the intersection line 203 and a plane 205 running across the top of each cell 201,202 so as to be tangent to the convex curvature of each cell 201,202. Note that the plane 205 is imaginary, but is useful as a reference in discussing the cleavage space 204. The cleavage space 205, also known as a cleavage void, is essentially a triangular shaped space, where the triangle has two concave sides. This invention takes advantage of this otherwise unused cleavage space 204 by filling it with components.

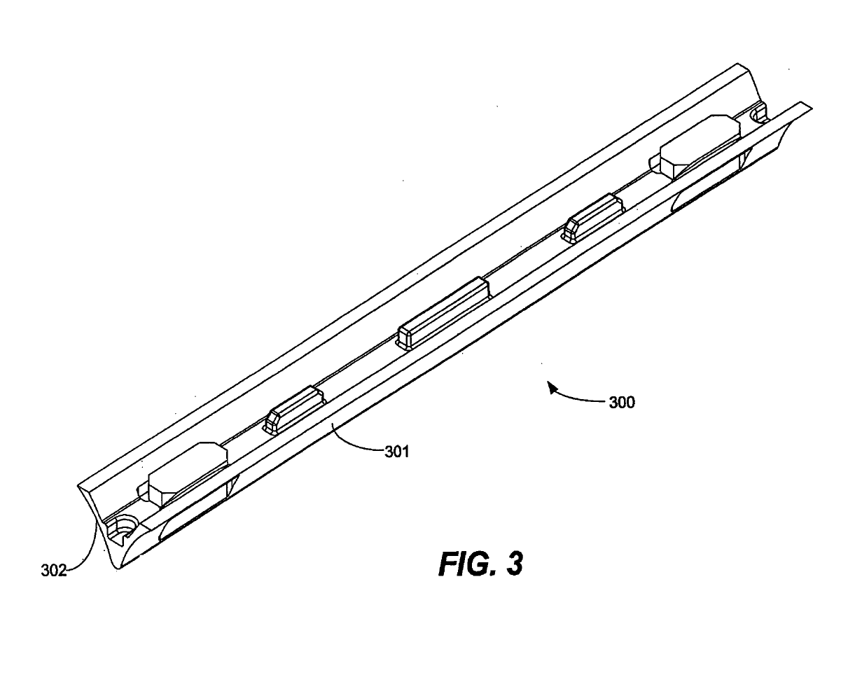

Referring now to FIG. 3, illustrated therein is an insulator 300 in accordance with the invention. This insulator 300, affectionately known as a “runner”, is a plastic member that has a geometric cross-section that fits within the cleavage space 204 of FIG. 2. The cross sectional shape is generally triangular, with two of the sides 301,302 having concave curvatures to mate between a pair of cylindrical cells. By way of example, if 18-650 cells are used, the concave curvatures of the sides 301,302 would have 9 mm radii, neglecting tolerances, to accommodate the outer, convex curves of the cell. The insulator 300 may be made from any of a number of plastics, including styrene, polystyrene, ABS, polycarbonates and the like. A preferred plastic is Noryl GTX 830. There are several manufacturing options available for construction of the insulator. One preferred method is injection molding.

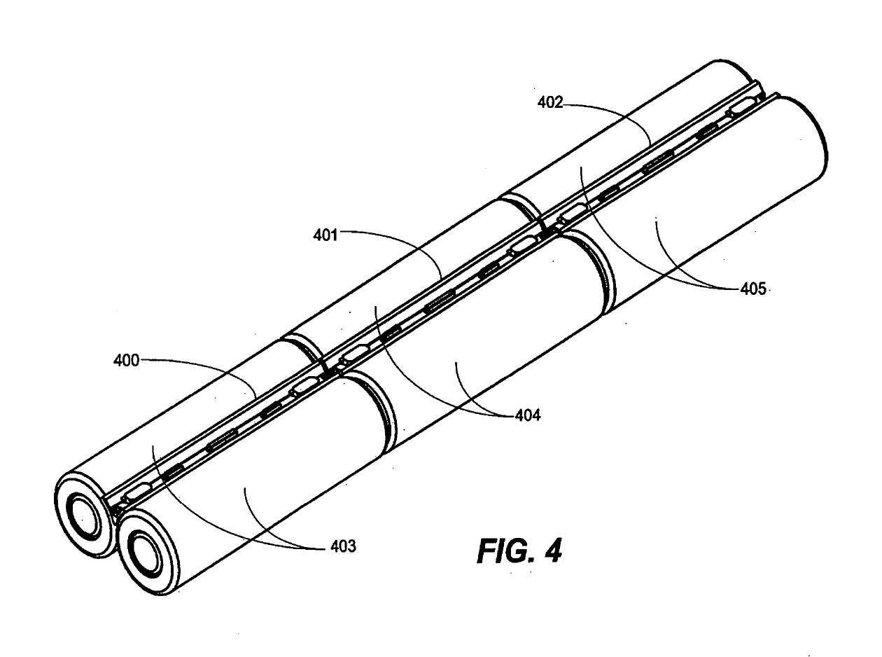

Turning to FIG. 4, three insulators 400,401,402 are disposed within the cleavage space of each pair 403,404,405 of a set of three pairs of cylindrical cells. When each insulator 400,401,402 is seated within the cleavage space or wedge area of the pairs 403,404,405 of cells, the concave curvatures of the insulators 400,401,402 mechanically mate with the convex curvatures of the cells.

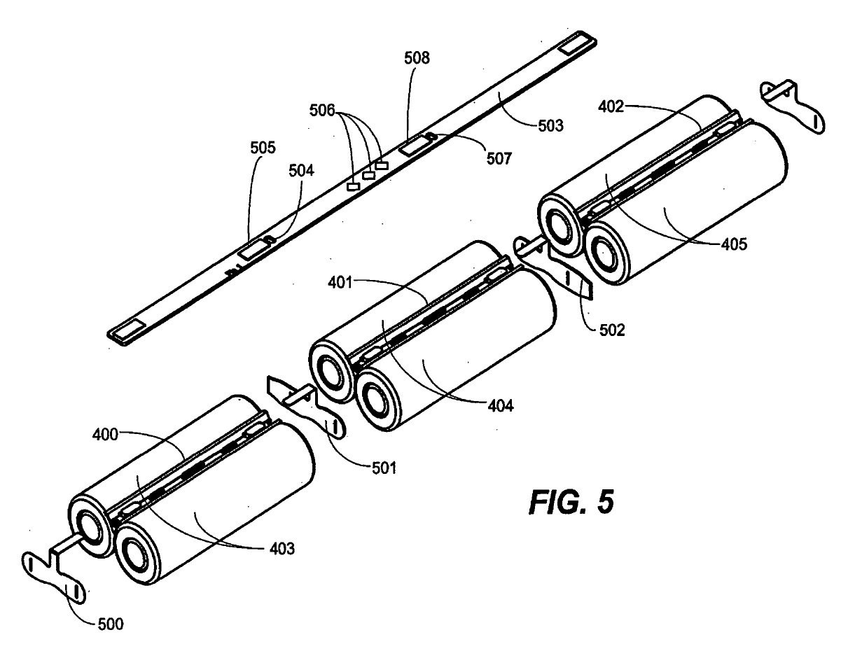

Turning now to FIG. 5, illustrated therein is an exploded view of a partial battery pack assembly in accordance with the invention. As with FIG. 4, three pairs of cells 403,404,405 are aligned end to end. The cells of FIG. 5 are shown in an exploded view so that the interconnection tabs 500,501,502 can be seen. The cells will be placed in an end to end configuration, for placement into a housing, after the tabs 500,501,502 have been attached. The tabs 500,501,502 serve as electrical connections to transmit energy from the cells to an external connector on the battery pack.

A first circuit board 503 is illustrated in FIG. 5. The first circuit board 503 includes at least one aperture 504 through which the tabs (e.g. 501) may pass for coupling the cells to the first circuit board. For multiple tab connections, multiple apertures 505,507 may be employed. An aperture may not be required for a tab (e.g. 500) that couples to the end of the first circuit board 503.

For ease and automation of assembly, a tab connection plate 505 or plates 505,508 may be included on the first circuit board 503. The tab connection plate 505 is a small piece of metal that may be attached to the first circuit board 503 by an automated process, like reflow soldering for example. When a tab connection plate 505 is used, the tab 501 may be coupled to the board by welding, rather than hand soldering. Welding increases the reliability of the electrical connection by eliminating the need for hand soldering.

Electrical components 506 may also be coupled to the first circuit board 503. For example, some applications require that the temperature of the cells be communicated to the host device. As such, a thermistor may be coupled to the first circuit board 503. Note that for the six-cell, exemplary embodiment, when the first circuit board 503 has a length greater than the length of two pairs of cells 403,404, the temperature of any particular pair of cells may be measured simply by placing the thermistor above that pair of cells. Additionally, multiple temperatures within the battery pack may be measured by using multiple thermistors.

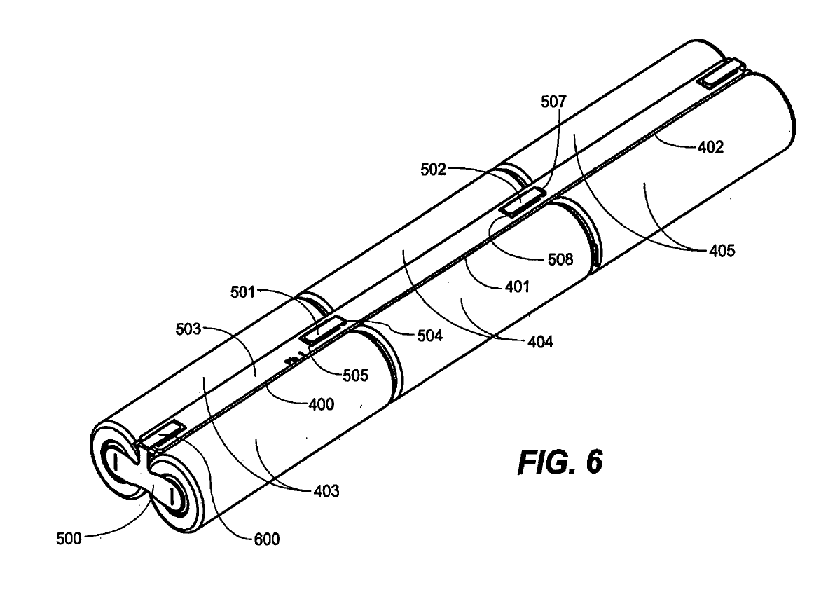

Turning now to FIG. 6, illustrated therein is the first circuit board 503 disposed atop the insulators 400,401,402 such that the first circuit board 503 and insulators 400,401,402 all fit within the cleavage space between the pairs of cells 403,404,405 that are coupled end to end. Tabs 501,502 pass through the apertures 504,507 and couple to tab connection plates 505,508. Tab 500 is able to wrap around the first circuit board 503 and also couples to a tab connection plate 600.

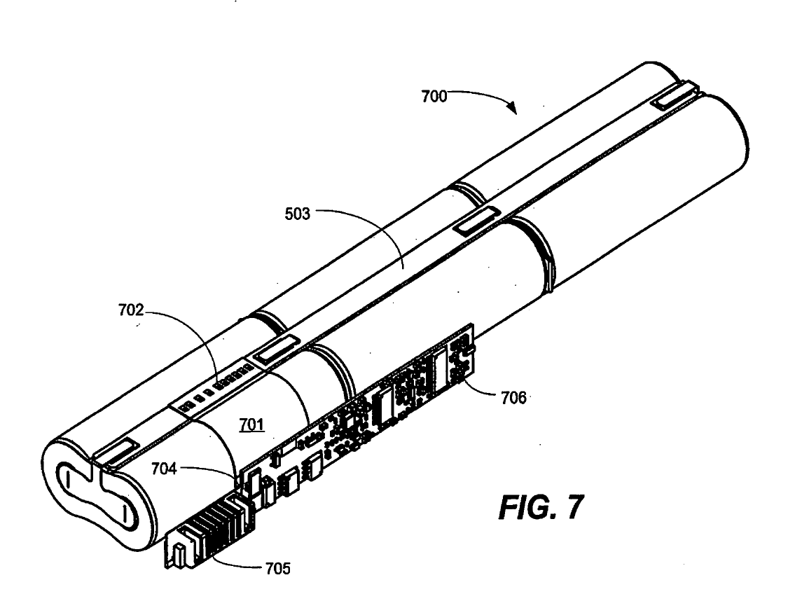

Turning now to FIG. 7, a flexible substrate 701 is coupled to the assembly 600 of FIG. 6. The flexible substrate 701 is a pliable member made from an insulating material, like Kapton™ for example, disposed about conductive metal traces. The flexible substrate 701 has a first end 702 and a second, distal end 703. The first end 702 is connected to the first circuit board 503. The flexible substrate 701 provides an electrical connection from the assembly 700 to the outside world.

The distal end 703 of the flexible substrate 701 is coupled to a second circuit board 704. The second circuit board 704 includes components like the external connector 705 and additional electronic circuitry 706, like charging circuitry, fuel gauging circuitry and safety circuitry. The cell assembly 700, flexible substrate 701 and second circuit board 704, once coupled together, are ready to be inserted into the housing of the battery pack.

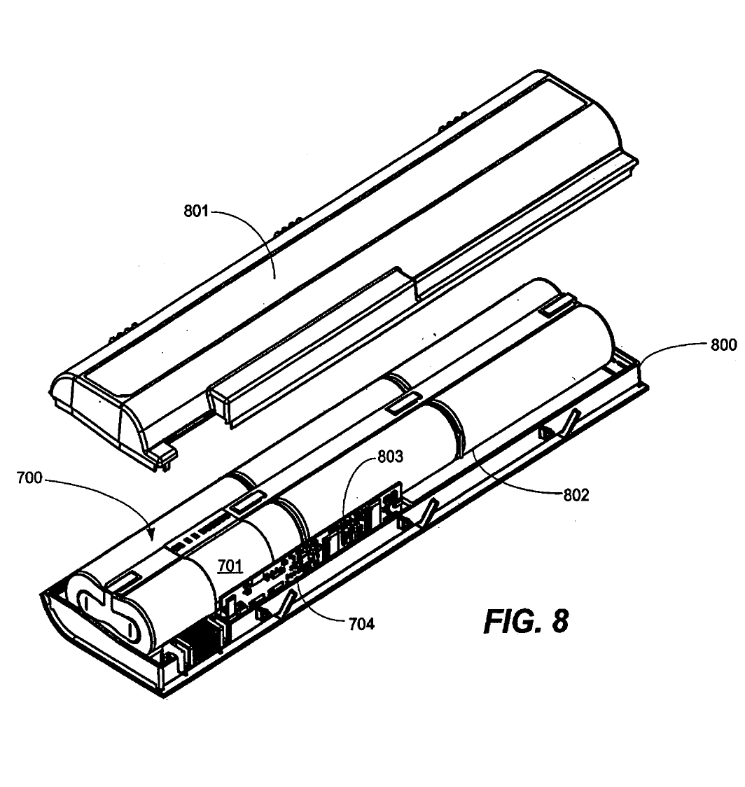

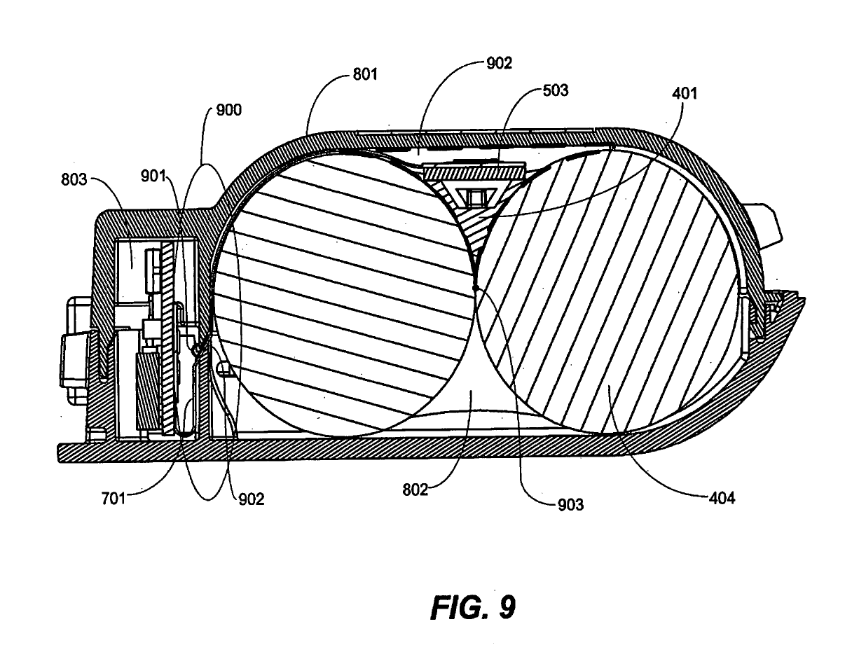

Turning now to FIG. 8, illustrated therein is the assembly of FIG. 7 seated in a housing, shown here having a top 801 and a bottom 800. The housing has a first chamber 802 and a second chamber 803. (These chambers, or compartments, will be more clearly shown in FIG. 9.) The cell assembly 700 is disposed in the first chamber 802, while the second circuit board 704 is disposed in the second chamber 803. The flexible substrate 701 serves as an electrical conduit between the first and second chambers 802,803.

Turning now to FIG. 9, illustrated therein is a cross section of the battery pack of FIG. 8. In this cross section, cell pair 404 can be seen, as can insulator 401 and the first circuit board 503. The upper housing 801 has been coupled to the bottom housing 800. Note that the upper housing 801 essentially becomes the plane that is tangent to cell pair 404, and that both the first circuit board 503 and insulator 401 fit within the cleavage space 902 formed by the top housing 801 and the intersection 903 of cell pair 404.

In this sectional view, the first chamber 802 and second chamber 803, first mentioned in the discussion of FIG. 8, can more clearly be seen. The first chamber 802 may be referred to as the “cell chamber”, and the second chamber 803 is sometimes referred to as the “sealing chamber”. The term “sealing” is used because a water-tight or liquid resistant barrier 900 is positioned between the first chamber 802 and second chamber 803. The water-tight seal 900 is formed by a plastic wall through which the flexible substrate passes. When the upper housing 801 and lower housing 800 are coupled together, a layer of adhesive 901 is applied to the opening 902 through which the flexible substrate 701 passes. The adhesive is applied about the flexible substrate 701. This adhesive, in conjunction with the barrier walls, provide a chamber 803 that is sealed in the sense that electrolyte leaked in the first chamber 802 can not pass to the second chamber 803.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

1. A multi-cell battery pack, comprising:
a. a plurality of cylindrical cells, wherein when two of the cylindrical cells are adjacent, a cleavage space exists between a line at which the two cells touch and a plane tangent to the two cells;
b. an insulator disposed within the cleavage space;
c. a first circuit board disposed atop the insulator, such that the first circuit board sits within the cleavage space, the first circuit board comprising at least one aperture;
d. a flexible circuit having a first end and a second end, the first end being coupled to the first circuit board;
e. a second circuit board coupled to the second end of the flexible circuit; and
f. a plurality of tabs coupling the plurality of cells to the first circuit board, wherein at least one of the tabs passes through the at least one aperture.

2. The circuit of claim 1, further comprising at least one tab connection plate electrically coupled to the first printed circuit board.

3. The circuit of claim 1, further comprising a housing having a first and a second chamber, wherein the plurality of cells are disposed in the first chamber, and the second circuit board is disposed in the second chamber.

4. The circuit of claim 3, wherein the first chamber and second chamber are separated by a water-tight seal.

5. The circuit of claim 4, wherein the flexible circuit passes through the water-tight seal.

6. A battery pack, comprising:
a. at least two cells, the cells each having an exterior casing with a convex curvature, wherein when the at least two cells are placed next to each other a cleavage void exists between the convex curvatures;
b. an insulator having at least two concave curvatures, the insulator being disposed within the cleavage void such that the at least two concave curvatures mechanically mate with the convex curvatures;
c. a plurality of tabs coupled to the at least two cells;
d. a first printed circuit board disposed atop the insulator, the first printed circuit board comprising at least one aperture;
e. a plurality of tab connection plates disposed on the printed circuit board;
f. a flexible substrate having a first end, the first end being coupled to the first printed circuit board;
g. a second printed circuit board, the second printed circuit board being coupled to a distal end of the flexible substrate; and
h. a housing, the housing comprising a main cavity and sealing chamber, wherein the second printed circuit board is disposed within the sealing chamber, further wherein the at least two cells are disposed in the main cavity.

7. The pack of claim 6, wherein at least one of the plurality of tabs passes through the at least one aperture.

8. The pack of claim 7, wherein the at least one of the plurality of tabs is coupled to at least one of the plurality of tab connection plates.

9. The pack of claim 8, wherein the coupling of the at least one of the plurality of tabs to the at least one of the plurality of tab connection plates is a weld.

10. The pack of claim 6, wherein the housing comprises an opening connecting the main cavity and the sealed chamber, wherein the flexible substrate passes through the opening.

11. The pack of claim 10, wherein the opening is filled with an adhesive about the flexible substrate.

12. The pack of claim 6, wherein a thermistor is coupled to the first printed circuit board.

13. The pack of claim 6, wherein charging circuitry is coupled to the second printed circuit board.

14. A battery pack for a portable electronic device, comprising:
a. at least six cylindrical cells, the at least six cylindrical cells being arranged within a housing in three pairs of two cylindrical cells, the three pairs of two cylindrical cells being arranged end to end;
b. at least three insulators, where one of the at least three insulators is disposed within a wedge area existing between one of the three pairs of two cylindrical cells;
c. a first circuit board, the first circuit board having a length greater than a length of two pairs of the three pairs two cylindrical cells, the two pairs being aligned end to end, wherein the first circuit board comprises at least two apertures;
d. a plurality of tabs coupling the at least six cylindrical cells to the first circuit board, wherein at least two tabs of the plurality of tabs pass through the at least two apertures; and
e. a flexible circuit coupled to the first circuit board.

15. The pack of claim 14, further comprising a second circuit board coupled to the flexible circuit.

16. The pack of claim 15, wherein the housing comprises a first and second compartment, the at least six cylindrical cells residing in the first compartment, and the second circuit board residing in the second compartment.

17. The pack of claim 16, wherein the first and second compartments are separated by a barrier that prevents liquid in the first chamber from passing to the second chamber.

18. The pack of claim 17, wherein the flexible circuit passes through the barrier.
